(19) United States
(12) Patent Application Publication
(10) Pub. No.: US 2009/0218730 A1
(43) Pub. Date: Sep. 3, 2009

(54) Acrylon Plastics Inc.

(76) Inventor: Craig McIntosh, Winnipeg (CA)

Correspondence Address: ADE & COMPANY INC., 2157 Henderson Highway, WINNIPEG, MB, R2G1P9, CA

(21) Appl. No.: 12/041,386

(22) Filed: Mar. 3, 2008

(51) Int. Cl. B28B 1/02

(52) U.S. Cl. 264/310; 425/470

(57) ABSTRACT

A rotational mold comprises a main portion for forming a hollow body and an inlet tube portion for forming an inlet tube on the hollow body. The inlet tube portion comprises a grooved collar and an annular end wall at one end of the collar for forming external threads about the inlet tube and a peripheral rim about an opening of the inlet tube. A shaft is joined to the annular end wall to extend through the collar to define an annular gap therebetween and includes material thereon spaced from the annular end wall which is arranged for resisting material being formed thereon during molding. The opening of the inlet tube of the finished molded part is thus arranged to be wholly formed by the shaft during molding without subsequent trimming being required.

### FIELD OF THE INVENTION

The present invention relates to a rotational mold and a method of use of the rotational mold for forming a tank having a fill hole formed by the mold.

### BACKGROUND

When forming tanks, it is common to rely on rotational molding in which starting material is placed within a mold which is heated and rotated such that the starting material takes the form of the mold to form a molded part. Upon removal from the mold, the molded part typically requires being subjected to the following post production work: i) mechanical removal of plastic material from the tank thereby creating a hole in the fill tube; and ii) removal of any debris from within the interior of the tank created by the first step. For a typical fuel tank, the time required to perform the foregoing could take between 20 minutes and 1.5 hours per tank. The duration of required trim/cleaning of the tank is dependent upon the specific tank design. The more intricate and complex the fuel tank design, the more time required to remove debris from the interior to ensure the tank is clean. If the tank is not clear of debris, this will cause a failure in the field resulting in an expensive service call to clear and correct the problem. In the application of fuel tanks, any debris in the tank causes the fuel pump to clog and shut down, thereby shutting down the vehicle preventing its use until such time as the tank is cleaned.

U.S. Pat. No. 5,415,316 belonging to Pemberton discloses a rotationally molded tank including a threaded neck opening formed by a mold including a main body portion for forming the main body of the tank and an inlet portion for forming the neck at an intended opening of the tank. Material is molded across the inlet opening during the rotational molding process subsequent to which a hole saw is required to form the opening in the neck of the tank. The additional step of sawing involves additional labour time and cost as well as contributing to the problems noted above with regard to debris within the interior of the tank which must be subsequently cleaned out.

### SUMMARY OF THE INVENTION

According to one aspect of the invention there is provided a rotational mold arranged to form a molded part comprising a hollow body having a hollow interior and an externally threaded inlet tube having an opening therethrough in communication with the hollow interior of the hollow body and a peripheral rim about the opening, the mold comprising:

a main portion arranged to form the hollow body of the molded part;

an inlet tube portion arranged to form the inlet tube of the molded part, the inlet tube portion comprising:
a collar having grooves formed about an inner surface thereof so as to be arranged to form external threads on the inlet tube of the molded part;
an annular end wall formed at one end of the collar so as to be arranged to form the peripheral rim about the opening of the molded part;
a shaft joined to the annular end wall and extending through the collar to define an annular gap between the inner surface of the collar and the shaft such that the shaft is arranged to form the opening in the inlet tube of the molded part; and
insulating material on the shaft spaced from the annular end wall, the insulating material being arranged to resist material of the molded part being formed thereon during rotational molding such that the opening is arranged to be substantially wholly formed by the shaft.

According to the present invention, it is possible to form a dimensional opening (a “fill hole”) within the threaded fill tube of a plastic fuel tank during the manufacturing process, such that any further work/modifications (i.e. “trimming”) is eliminated from having to be performed to the part subsequent to production when rotational molding.

By providing a rotational mold including an inlet tube portion with a shaft arranged to wholly form the opening in the finished part during the rotational molding process, no subsequent machining is required thus saving considerable time and cost as well as avoiding any potential problems associated with debris in a tank.

According to a second aspect of the present invention there is provided a method of forming a molded part comprising a hollow body having a hollow interior and an externally threaded inlet tube having an opening therethrough in communication with the hollow interior of the hollow body and a peripheral rim about the opening, the method comprising:

providing a rotational mold comprising a main portion and an inlet tube portion;

forming the hollow body in the main portion of the rotational mold;

forming the inlet tube in the inlet tube portion of the rotational mold by arranging the inlet tube portion to comprise a collar;

forming external threads on the inlet tube of the molded part by providing grooves about an inner surface of the collar;

forming a peripheral rim about the opening of the inlet tube by providing an annular end wall at one end of the collar;

forming the opening of the inlet tube by providing a shaft joined to the annular end wall which extends through the collar to define an annular gap between the inner surface of the collar and the shaft;

insulating the shaft at a location spaced from the annular end wall such that the opening in the inlet tube is wholly formed by the shaft;

filling the rotational mold with starting material;

heating and rotating the rotational mold.

The shaft is preferably insulated with Teflon™.

The annular gap defined between the shaft and the collar preferably has a suitable dimension such that the annular gap is arranged to be substantially filled with material during rotational molding.

The shaft is preferably concentric with the collar.

The shaft is preferably tapered such that a diameter of the shaft decreases from the annular end wall towards the insulating material.

When the insulating material spans an end of the shaft opposite the annular end wall, the insulating material and the shaft are preferably near in diameter to one another at a junction between the insulating material and the shaft.

The insulating material is preferably also tapered such that a diameter of the insulating material decreases with increasing distance from the annular end wall.

There may be provided an annular shoulder portion at one end of the collar opposite the annular end wall so as to be arranged to form a shoulder about the inlet tube of the molded part. In this instance, the insulating material is preferably positioned farther from the annular end wall than the annular shoulder portion such that the shaft is arranged to form an inner portion of the inlet tube of the molded part which projects into the hollow interior.

There may be provided a rotational molding vent for venting the molding in communication through the shaft.

In the accompanying illustrated embodiment, the main portion is arranged to form the hollow body of a fuel tank and the inlet tube portion is arranged to form the inlet tube of the fuel tank.

One embodiment of the invention will now be described in conjunction with the accompanying drawings in which:

### BRIEF DESCRIPTION OF THE DRAWINGS

FIG. 1 is a sectional view of a prior art rotational mold of a tank including an inlet opening in which trimming is required subsequent to the molding process.

FIG. 2 is a sectional view along the line 2-2 of FIG. 4 of the rotational mold according to the present invention.

FIG. 3 is a perspective view of the inlet tube portion of the rotational mold according to FIG. 2.

FIG. 4 is an interior end elevational view of the inlet tube portion of the mold.

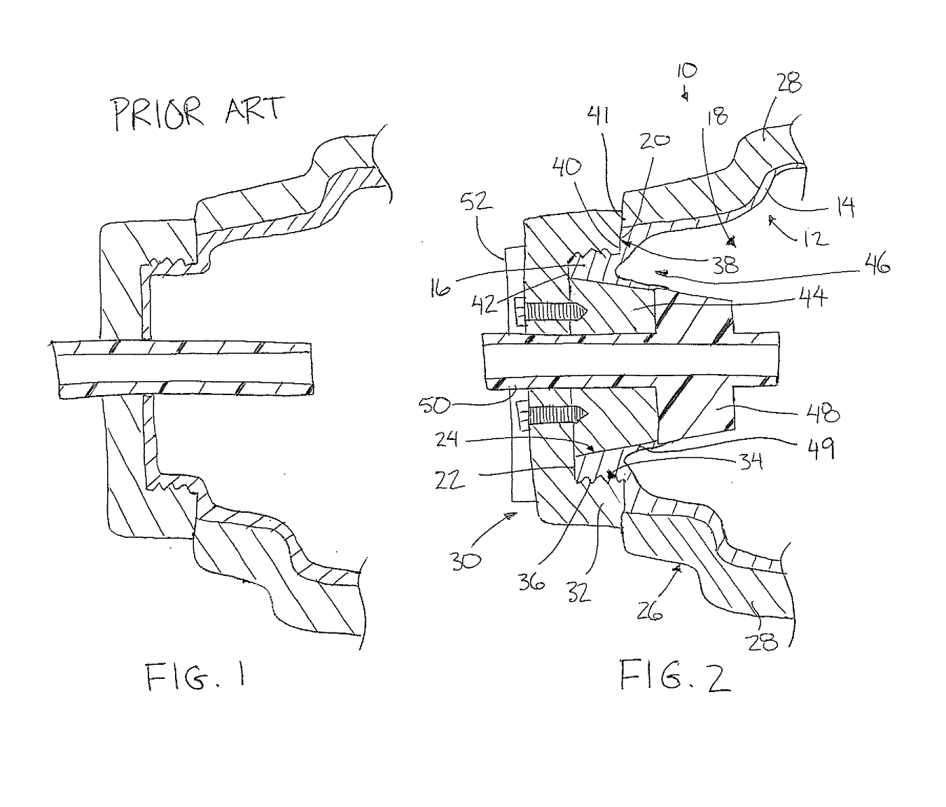

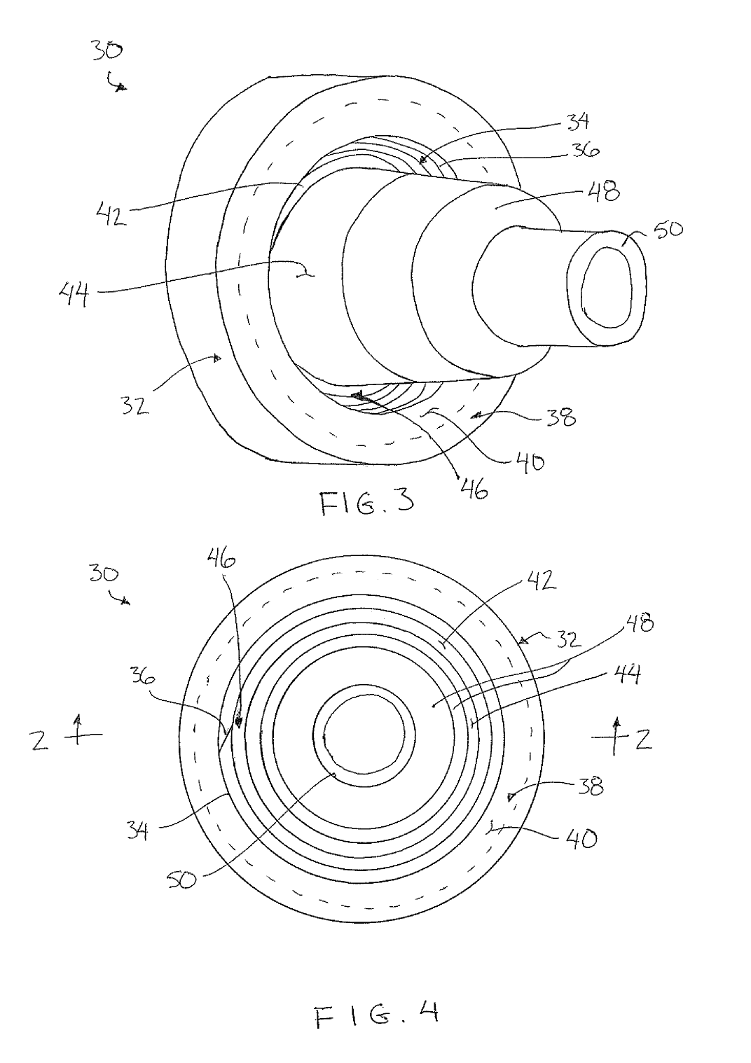

In the drawings like characters of reference indicate corresponding parts in the different figures.

### DETAILED DESCRIPTION

Referring to the accompanying figures there is illustrated a rotational mold generally indicated by reference numeral 10. The mold 10 is particularly suited for forming a molded part 12 of the type including a hollow body 14 and an inlet tube 16 in communication with the hollow body for access into the interior thereof. In the illustrated embodiment the hollow body comprises a fuel tank and the inlet tube comprises a fill tube of the fuel tank.

The hollow body 14 of the molded part comprises walls which surround and fully enclose a hollow interior 18 of the part. The inlet tube 16 communicates through one of the walls surrounding the hollow interior of the main hollow body 14. The inlet tube 16 is generally tubular projecting externally outward from the body. An external surface of the inlet tube is externally threaded for threadably receiving a cap thereon to enclose the body. An annular shoulder 20 is formed about the inlet tube at the base thereof where the inlet tube connects to the walls of the body in the form of an annular flat end face which lies perpendicular to an axis of the inlet tube. A free end of the inlet tube opposite the base thereof also defines an annular end face 22 which forms a peripheral rim about an opening 24 extending through the inlet tube in communication with the hollow interior of the main body.

The rotational mold 10 comprises a main portion 26 which is formed of plural sections 28 assembled together to form an enclosure of walls which surround and define the shape of the main body 14 of the molded part formed therein during rotational molding. An opening is provided in the main portion 26 which receives an inlet tube portion 30 of the mold. The inlet tube portion is arranged to form the inlet tube 16 of the molded part therein during the rotational molding process. The inlet tube generally comprises a collar 32 which is generally cylindrical in shape with an inner surface 34 thereof being arranged to form the outer surface of the tube 16. The inner surface 34 is internally grooved by a helical pattern of grooves 36 which are arranged to form external threads on the inlet tube 16. The inner surface 34 has a near constant interior diameter along a length of the collar in the axial direction thereof.

An interior end face 38 of the collar is generally flat and annular in shape so as to lie generally perpendicular to an axis of the collar. The end face includes an inner portion extending about a circumference of the collar which defines an annular shoulder portion 40 of the mold which is arranged to form the shoulder 20 on the molded part about the base of the inlet tube. The end face 38 of the inlet tube portion of the mold also includes an outer portion 41 extending circumferentially about the collar radially outward from the inner portion which is suitably arranged for abutment against a peripheral rim about the opening in the main portion 26 of the mold which receives the inlet tube portion of the mold therein.

The inlet tube portion of the mold also includes an annular end wall 42 which spans one end of the collar 32 opposite the annular shoulder portion 40. The annular end wall 42 forms an end face of the inlet tube 16 as the end wall 42 spans radially inward from the inner surface of the collar towards the collar axis to lie substantially perpendicular to the axis of the collar. The flat end face formed by the end wall 42 on the molded part comprises the flat peripheral rim of the inlet tube which lies in a plane which is perpendicular to the inlet tube axis and which extends circumferentially about the opening 24 of the inlet tube.

The inlet tube portion of the mold further includes a shaft 44 mounted on the annular end wall 42 to extend axially through the collar 32 concentrically therewith. The shaft 44 is jointed at one end to the end wall to project inwardly therefrom beyond the end face 38 of the collar so as to project into the hollow interior of the main portion 26 of the mold. The shaft 44 defines an annular gap 46 between the inner surface of the collar and the outer diameter of the shaft to form the inlet tube of the molded part therebetween. The gap is arranged to have suitable dimensions so that the gap is fully filed with moldable material during the rotational molding process. The opening through the inlet tube in the finished molded part is formed by the shaft such that the outer diameter of the shaft corresponds to the inner diameter of the finished opening in the finished part after molding and cleaning operations have been completed.

The diameter of the shaft tapers so as to be reduced in diameter with increasing distance of the shaft from the annular end wall 42 upon which it is joined. The gap between the shaft and surrounding collar thus has increasing radial dimension from the end wall 42 towards the free inner end of the shaft within the interior of the main body for facilitating the flow of molding material into the gap during the rotational molding process.

A cap 48 is mounted at the inner end of the shaft opposite the annular end wall 42. The shaft comprises Teflon which acts as a insulating material and a non-stick material to resist any molding material being deposited thereon during the rotational molding process. The cap 48 of insulating Teflon material is formed to be substantially continuous with the shaft to extend in the axial direction of the collar into the hollow interior of the main body from the end of the shaft. The cap 48 and the shaft 44 are near in diameter to one another at the junction therebetween. In the illustrated embodiment the cap is shown to be slightly larger in diameter than the narrowest diameter of the shaft at the junction thereof by a dimension which corresponds to less than the amount of shrinkage of the molded part during cooling after the rotational molding process so that the cap can still be released by sliding removal through the molded inlet tube formed by the shaft during the molding process. The cap 48 is similarly tapered so as to be reduced in diameter from a greatest diameter at the junction with the shaft to decrease with increasing distance from the end wall to a narrowest diameter at the free inner end thereof. The cap resists the formation of material during the molding process on the end of the shaft 44 so that the finished opening 24 of the finished part 12 is formed wholly by the shaft during the molding process without any subsequent machining being required.

The shaft extends through the collar from the end wall 42 in an axial direction so as to be longer than the collar, thus defining an inner portion of the shaft which projects inwardly into the hollow interior of the main body of the mold beyond the annular shoulder 20 formed by the end face 38. The insulating material of the cap is thus positioned farther from the annular end wall 42 than the annular shoulder portion 38 of the mold such that the inner portion of the shaft is arranged to form an inner portion 49 of the inlet tube of the molded part which projects into the hollow interior of the main body.

The shaft 44, the annular end wall 42 and the collar 32 are all formed integrally with one another so as to be continuous of like material, for example aluminium or other suitable material for forming a mold during a rotational molding process. For ease of manufacturing, in the illustrated embodiment the shaft is secured to the end wall be fasteners inserted through the exterior side of the end wall 42.

The rotational mold is arranged to be vented through the shaft 44 and end wall upon which it is supported. Venting is provided by a rotational molding vent tube 50 formed integrally with the Teflon cap 48 at the end of the shaft. The vent tube is mounted concentrically through the shaft and the end wall by press fitting the tube into a bore through the shaft and end wall. The vent tube 50 is filled with conventional material used in rotational molding to prevent escape of molding material from the mold through the vent tube during rotational molding.

The exterior of the end wall 42 includes suitable protrusions 52 formed thereon which extend axially outward for abutment with a suitable clamping mechanism to hold the inlet tube portion of the mold spanning across the opening in the main portion of the mold during the molding process.

In use, a user first assembles the various portions of the mold together such that the inlet tube portion is clamped to span across the opening in the main portion. Starting material in the form of suitable plastic powder and the like is placed in the mold. The mold is heated and rotated in the conventional manner of rotational molding so that the plastic powder forms a layer adhering to the inner surfaces of the mold with the exception of the Teflon surfaces. The tapering dimension of the gap between the shaft and the collar of the inlet tube portion of the mold is suitably sized to be substantially filled with the molding material during the rotational molding process. Venting occurs through the vent tube 50 in the inlet tube portion of the mold. After the mold has sufficiently cooled, the inlet tube portion of the mold is first unscrewed for separation from the main portion of the mold. Separation of the main portion sections permits the finished part to be removed from the mold without any further machining modification being required to the opening in the inlet tube due to the configuration of the inlet portion of the mold.

According to the present invention a trim less “fill hole” in a plastic fuel tank can be created during the molding process. This is accomplished by fitting the internal cavity of a fuel tank mold with an aluminum and Teflon fixture in such a fashion as to accommodate same. The aluminum fixture is machined to accommodate the fuel cap thread design. In order for the thread design to be obtained during production and the trim less fill hole created, a tapered shaft of aluminum and Teflon is added to the aluminum fixture.

The tapering of the aluminum shaft allows the resin to flow freely during the manufacturing process and correctly set up the threads required to accept a fuel cap. In the absence of the shaft, the hole must be mechanically cut open and the tank cleaned of debris. Similarly, in the absence of a tapered shaft, i.e. say a straight shaft, the resin will not flow freely and the threads may not set up properly causing the tank to be scrapped.

The taper of the shaft should be greater than 5 degrees. The greater the degree of the taper, the more flow of plastic during fabrication, and thus the greater the likely hood of ensuring the threads set up correctly. However, the greater the taper the narrower the interior hole on the inside which must be considered in the application.

The use of Teflon in the application is to control the depth of the interior throat wall created. Plastic will not stick and form where the Teflon is.

The embodiment described herein relates to the creation of the fill hole of a fuel tank, however, it could be applied and used in the creation any hole in a tank so long as the interior cavity of the tank is able to accommodate the interior plastic wall created during the process.

The innovation specifically relates to the application and use of Paxon 7203 plastic resin “Cross Link”. The application to cross link resin is important, as unlike most other plastic resins, whereby the location of a hole can be obtained by thinning the plastic wall during production to such a point as it can be easily removed by simply manually pealing the section away by hand. Cross Link once formed, cannot be peeled off and must be mechanically removed.

The innovation will work with other plastic resin such as Polyethylene.

The size of the opening or tank is not relevant. The innovation can be applied to any hole.

An added advantage of the innovation is that the surface area obtains a smooth finished look. In some applications, additional work would be required to obtain same were it not for the innovation described herein.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A rotational mold arranged to form a molded part comprising a hollow body having a hollow interior and an externally threaded inlet tube having an opening therethrough in communication with the hollow interior of the hollow body and a peripheral rim about the opening, the mold comprising:
a main portion arranged to form the hollow body of the molded part;
an inlet tube portion arranged to form the inlet tube of the molded part, the inlet tube portion comprising:
a collar having grooves formed about an inner surface thereof so as to be arranged to form external threads on the inlet tube of the molded part;
an annular end wall formed at one end of the collar so as to be arranged to form the peripheral rim about the opening of the molded part;
a shaft joined to the annular end wall and extending through the collar to define an annular gap between the inner surface of the collar and the shaft such that the shaft is arranged to form the opening in the inlet tube of the molded part; and
insulating material on the shaft spaced from the annular end wall, the insulating material being arranged to resist material of the molded part being formed thereon during rotational molding such that the opening is arranged to be substantially wholly formed by the shaft.

2. The mold according to claim 1 wherein the annular gap defined between the shaft and the collar has a suitable dimension such that the annular gap is arranged to be substantially filled with material during rotational molding.

3. The mold according to claim 1 wherein the shaft is concentric with the collar.

4. The mold according to claim 1 wherein the shaft is tapered such that a diameter of the shaft decreases from the annular end wall towards the insulating material.

5. The mold according to claim 1 wherein the insulating material spans an end of the shaft opposite the annular end wall, the insulating material and the shaft being near in diameter to one another at a junction between the insulating material and the shaft.

6. The mold according to claim 5 wherein the insulating material is tapered such that a diameter of the insulating material decreases with increasing distance from the annular end wall.

7. The mold according to claim 1 wherein there is provided a annular shoulder portion at one end of the collar opposite the annular end wall so as to be arranged to form a shoulder about the inlet tube of the molded part.

8. The mold according to claim 7 wherein the insulating material is positioned farther from the annular end wall than the annular shoulder portion such that the shaft is arranged to form an inner portion of the inlet tube of the molded part which projects into the hollow interior.

9. The mold according to claim 1 wherein there is provided a rotational molding vent communicating through the shaft.

10. The mold according to claim 1 wherein the main portion is arranged to form the hollow body of a fuel tank and the inlet tube portion is arranged to form the inlet tube of the fuel tank.

11. A method of forming a molded part comprising a hollow body having a hollow interior and an externally threaded inlet tube having an opening therethrough in communication with the hollow interior of the hollow body and a peripheral rim about the opening, the method comprising:
providing a rotational mold comprising a main portion and an inlet tube portion;
forming the hollow body in the main portion of the rotational mold;
forming the inlet tube in the inlet tube portion of the rotational mold by arranging the inlet tube portion to comprise a collar;
forming external threads on the inlet tube of the molded part by providing grooves about an inner surface of the collar;
forming a peripheral rim about the opening of the inlet tube by providing an annular end wall at one end of the collar;
forming the opening of the inlet tube by providing a shaft joined to the annular end wall which extends through the collar to define an annular gap between the inner surface of the collar and the shaft;
insulating the shaft at a location spaced from the annular end wall such that the opening in the inlet tube is wholly formed by the shaft;
filling the rotational mold with starting material;
heating and rotating the rotational mold.

12. The method according to claim 11 including filling the annular gap defined between the shaft and the collar with material during heating and rotation of the rotational mold.

13. The method according to claim 11 including positioning the shaft concentric with the collar.

14. The method according to claim 11 including forming the shaft to be tapered such that a diameter of the shaft decreases from the annular end wall towards the insulating material.

15. The method according to claim 11 including forming the insulating material to span an end of the shaft opposite the annular end wall such that insulating material and the shaft are near in diameter to one another at a junction between the insulating material and the shaft.

16. The method according to claim 15 including forming the insulating material to be tapered such that a diameter of the insulating material decreases with increasing distance from the annular end wall.

17. The method according to claim 11 including forming a shoulder about the inlet tube of the molded part by providing an annular shoulder portion at one end of the collar opposite the annular end wall.

18. The method according to claim 17 including positioning the insulating material farther from the annular end wall than the annular shoulder portion such that the shaft is arranged to form an inner portion of the inlet tube of the molded part which projects into the hollow interior.

19. The method according to claim 11 including venting the rotational mold through the shaft.

20. The method according to claim 11 wherein the molded part comprises a fuel tank.
